(19) United States
(12) Patent Application Publication
(10) Pub. No.: US 2007/0251095 A1
(43) Pub. Date: Nov. 1, 2007

(54) Cutter

(76) Inventor: Tooru Nagasoe, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/476,668

(22) Filed: Jun. 29, 2006

(30) Foreign Application Priority Data
Apr. 27, 2006 (JP) JP2006-123679

(51) Int. Cl. B26D 3/16

(52) U.S. Cl. 30/92

(57) ABSTRACT

Provided is a cutter capable of cutting a pipe-shaped material so as to produce a cut surface which is almost perfectly perpendicular to a longitudinal direction of the pipe-shaped material. A blade 1 has a disc-like base plate 2 with a mounting hole 3 provided at a center of the base plate 2. An outer periphery of the base plate 2 is sharpened to function as a blade edge 4. The blade 1 has a level surface 5 which is perpendicular to an axial direction of the blade 1 and a sloped surface 6 which is slanted so that a thickness of a central portion of the base plate 2 is larger than a thickness of a periphery of the base plate 2. Since the sloped surface 6 is only provided on one side of the blade edge 4, the blade 1 is asymmetric when viewed from a side thereof.

### BACKGROUND OF THE INVENTION

1. Field of the Invention

The present invention relates to a cutter used for cutting pipes or the like.

2. Description of the Related Art

A cutter is used in cutting various materials. The structure of the blade edge of a cutter is designed differently depending on the shape and property of the material to be cut. For example, as a cutter used for a brittle material such as plate glass, a semiconductor wafer, or ceramics, Unexamined Japanese Patent Publication No. 2002-121040 discloses a cutter wheel for a brittle material substrate, which has a V-shaped blade provided on the periphery of a disc wheel. The V-shaped blade of this cutter wheel is manufactured so that the blade edge or the ridge portion of the blade has a polygonal shape.

In the above cutter described in Unexamined Japanese Patent Publication No. 2002-121040, the structure of the blade edge is designed on the assumption that the cutter is used for cutting a plate material and has advantages in this particular use. On the other hand, when cutting a material of other shapes than a plate, such as a pipe, for example, a different force acts on the material from the cutter during the cutting process. In this case, the structure of the blade edge has to be considered from a different viewpoint so as to realize the cutting with a high accuracy.

FIGS. 4A to 4C show a structure of a blade for a cutter which has been conventionally used for cutting a pipe-shaped material.

In a blade 51 shown in FIG. 4A, a mounting hole 53 is provided at a center of a disc-like base plate 52. An outer periphery of the base plate 52 is sharpened to function as a blade edge 54. When viewing the blade 51 from the side, as shown in FIG. 4B, sloped surfaces 55 are formed on both sides of the blade edge 54 with the blade edge 54 as the axis of symmetry so that the thickness of a central portion of the base plate 52 is larger than the thickness of a peripheral portion of the base plate 52. In other words, in the conventional blade 51, the thickness of the blade 51 increases on both sides of the blade edge 54 in a similar manner so that the thickness increases toward the center of the blade 51 from the blade edge 54 formed on the outer periphery.

When a pipe-shaped material is cut with the above conventional blade, a cut surface 57 of a material 56 is slanted as shown in FIG. 4C and cannot have a section perpendicular to the longitudinal direction of the pipe-shaped material. If the pipes having the slanted cut surfaces are connected to each other, a gap is generated between the connected surfaces. Moreover, this blade also causes burrs during the cutting process, which requires extra work for removing the burrs.

Pipe-shaped materials are being used in a variety of fields. In particular, when used in an apparatus like an air-conditioner where a gas such as a refrigerant flows through a pipe, if a gas leaks from a connection between pipes or a connected portion of a pipe with a flare which opens like a bugle, the natural environment is damaged. In order to prevent a gas from leaking from the connections, the pipe must be cut in such a manner that the cut surface thereof has a section which is almost perfectly perpendicular to the longitudinal direction of the pipe.

In view of the above problems, an object of the present invention is to provide a cutter for cutting a pipe-shaped material which is capable of cutting the pipe-shaped material so as to produce a cut surface which is almost perfectly perpendicular to the longitudinal direction of the pipe-shaped material.

### SUMMARY OF THE INVENTION

In order to solve the above problems, a cutter according to the present invention is a cutter with a blade having a blade edge provided on an outer periphery of a disc-like base plate, the blade comprising a level surface which is perpendicular to an axial direction of the base plate and a sloped surface which is provided on an opposite side of the level surface and slanted so that a thickness of the blade increases toward a central portion of the blade.

By providing a level surface which is perpendicular to the axial direction of the base plate, the angle of the level surface of the blade edge is also maintained against a material to be cut, which produces a cut surface which is almost perfectly perpendicular to the longitudinal direction of the material. In addition, by providing the sloped surface on one side of the blade, the one side of the blade has a sufficient thickness to assure mechanical strength so that this portion functions as a support for strengthening the blade when cutting. Accordingly, while maintaining the strength of the blade edge, the cut surface can be formed to have a surface which is almost perfectly perpendicular to the longitudinal direction of the cut material.

In the present invention, preferably, an angle of the sloped surface against the level surface may be 7 degrees or more.

When the angle of the sloped surface against the level surface is less than 7 degrees, the thickness of the blade becomes too small to maintain the strength.

Preferably, a cutter according to the present invention may have a handle for adjusting a cutting depth of the blade and means for fixing the blade in a certain position in a step-by-step manner when operating the handle.

By fixing the blade in a certain position a step-by-step manner, when turning the cutter with the handle to cut a material, the position of the blade is held without slipping. Therefore, poor accuracy of a cut surface due to slipping of a blade can be prevented.

In the present invention, the means for fixing the blade in a certain position in a step-by-step manner may be a mechanism comprising a plurality of concave portions formed at regular intervals therebetween on an expanded portion of a shaft to which the blade is mounted, and a contact pin which comes into contact with the concave portions, wherein the shaft is fixed when the contact pin fits one of the concave portions. The contact pin has a ball disposed at a distal end of the contact pin and a spring member which protrudes and retracts the ball with an elastic force of the spring member.

Each of the concave portions formed on the expanded portion of the shaft comes into contact with the contact pin with a point contact on the ball disposed at the distal end of the contact pin. Accordingly, there is very little wear on the concave portions and the contact pin even after a long period of use, which leads to high durability.

According to the present invention, it is possible to realize a cutter capable of cutting a pipe-shaped material to produce a cut surface which is almost perfectly perpendicular to the longitudinal direction of the pipe-shaped material.

### BRIEF DESCRIPTION OF THE DRAWINGS

In the accompanying drawings:

FIGS. 1A, 1B, 1C and 1D illustrate a structure of a blade of a cutter according to an embodiment of the present invention;

FIG. 2 illustrates a structure of a cutter according to an embodiment of the present invention;

FIGS. 3A, 3B and 3C illustrate an inside of a handle in details; and

FIGS. 4A, 4B and 4C illustrate a structure of a blade of a cutter which has been conventionally used for cutting a pipe-shaped material.

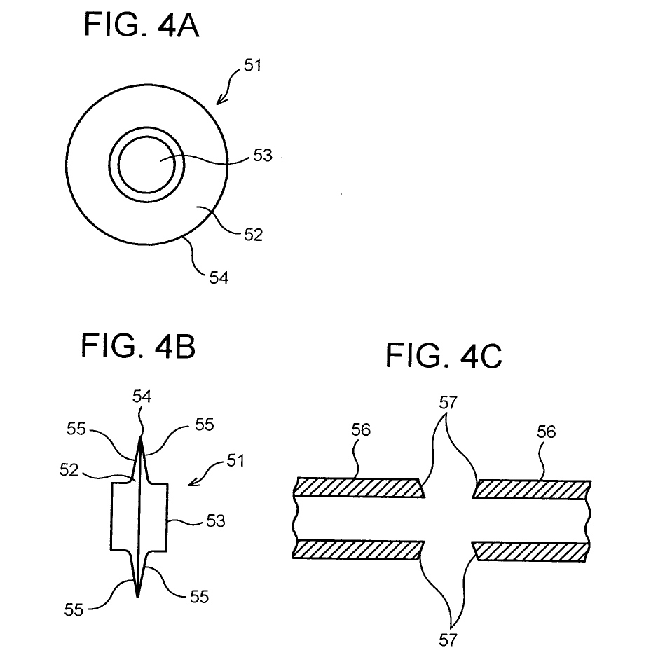

### DETAILED DESCRIPTION OF THE PREFERRED EMBODIMENT

With reference to the accompanied drawings, embodiments of the present invention will be explained below.

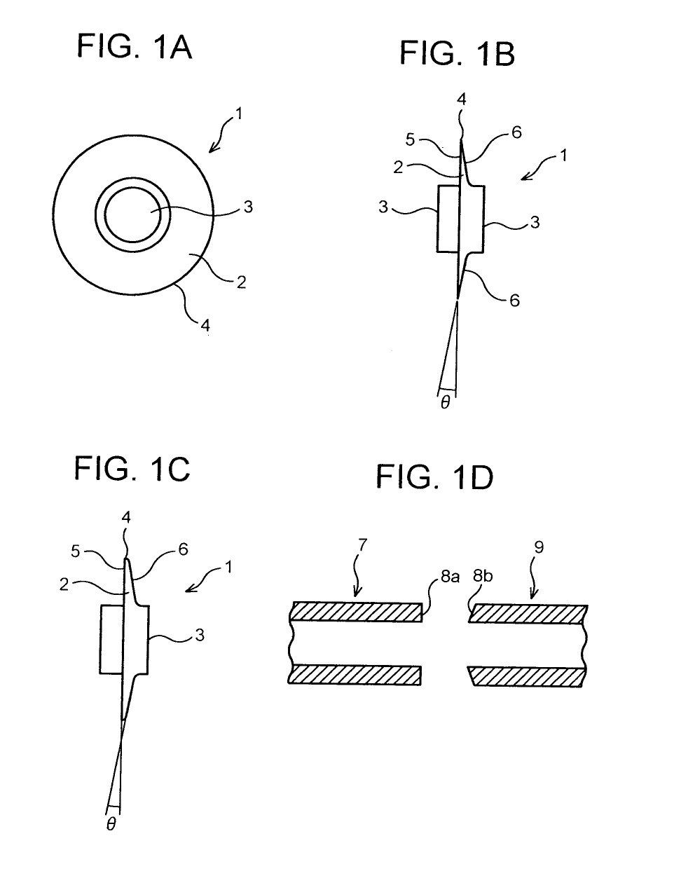

FIGS. 1A to 1D illustrate a structure of a blade of a cutter according to an embodiment of the present invention. FIG. 1A is a front view of the blade, and FIG. 1B is a side view of the blade of FIG. 1A.

In FIG. 1A, a blade 1 has a disc-like base plate 2 with a mounting hole 3 provided at a center of the base plate 2. An outer periphery of the base plate 2 is sharpened to function as a blade edge 4. On the mounting hole 3, a bearing may be provided for smooth rotation of the base plate 2. The blade 1 has, as shown in FIG. 1B, a level surface 5 which is perpendicular to an axial direction of the blade 1 and a sloped surface 6 which is provided on an opposite side of the level surface 5 and slanted so that a thickness of a central portion of the base plate 2 is larger than a thickness of a periphery of the base plate 2.

In other words, in the blade 1 of the present invention, the sloped surface 6 is only provided on one side of the blade edge 4 to form an asymmetry when the blade 1 is viewed from the side, which is an important characteristic of the invention. As long as the blade has such an asymmetrical form, an outer peripheral portion of the blade 1 may have a larger angle of inclination as shown in FIG. 1C. This structure stabilizes a cutting operation when the blade 1 comes into contact with a pipe-shaped material.

FIG. 1D illustrates cut surfaces of a pipe-shaped material that has been cut into two cut portions 7 and 9 with the blade 1. In FIG. 1D, in the cut portions 7 and 9, the cut portion 7 which is used after cutting has a cut surface 8a perpendicular to a longitudinal direction of the pipe-shaped material because the level surface 5 of the blade 1 is applied to the cut portion 7 when cutting. On the other hand, the cut portion 9 which is disposed of after cutting has a slanted cut surface 8b since the sloped surface 6 of the blade 1 is applied to the cut portion 9. Namely, with the blade 1 of the present invention which has an asymmetrical form, only the cut surface 8a that is used after cutting can be formed to be perpendicular to the longitudinal direction of the pipe-shaped material, thereby rationalizing the cutting operation.

Furthermore, the sloped surface 6 provided on one side of the blade 1 increases a thickness of the blade 1 on one side, which assures mechanical strength and thus supports the strength of the blade 1 when cutting.

An angle θ of the sloped surface 6 against the level surface 5 is 7 degrees or more. In order to maintain this angle after a long period of use, hardness of a metal forming the blade 1 may preferably be in a range from 62 to 64 in Rockwell hardness. It may also be preferable to employ a metal which has a relatively high viscosity.

Next, a cutter using the above blade will be explained below.

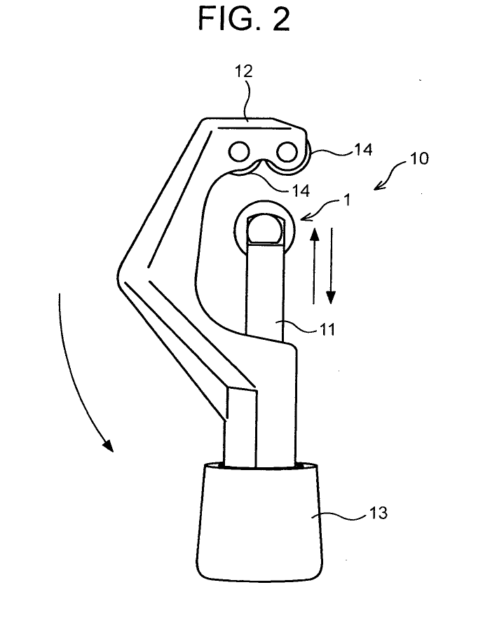

FIG. 2 illustrates a structure of a cutter according to an embodiment of the present invention.

In a cutter 10 in FIG. 2, the blade 1 is mounted at a distal end of a shaft 11. An opposite end of the shaft 11 is supported inside a handle 13 via an arm 12. As the handle 13 turns, the shaft 11 is movable in a direction shown by straight arrows. Facing the blade 1, two bearings 14 are mounted on the arm 12. A pipe-shaped material to be cut is put between the blade 1 and the bearings 14 so that a longitudinal direction of the pipe-shaped material is perpendicular to a sheet surface of the drawing. The cutter 10 is turned in a direction shown by a curved arrow, thereby cutting the pipe-shaped material.

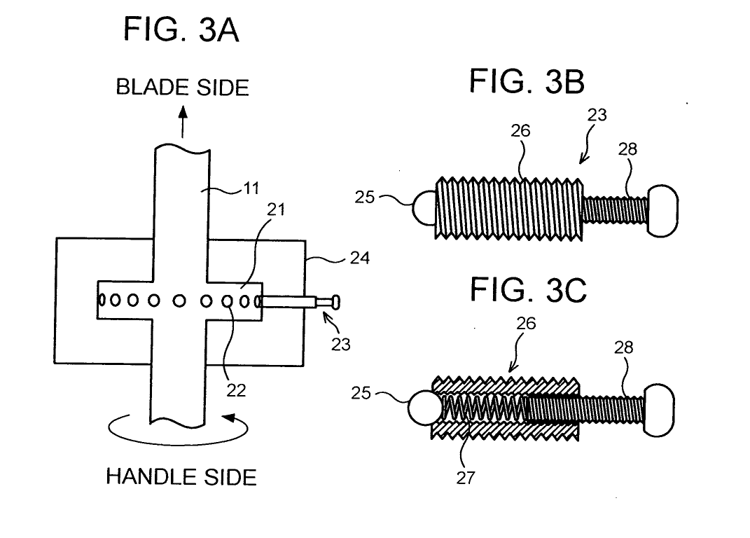

FIGS. 3A to 3C illustrate an inside of the handle 13 in details. In FIG. 3A, the shaft 11 has an expanded portion 21 inside the handle 13. On an outer surface of the expanded portion 21, a plurality of concave portions 22 are formed at regular intervals therebetween. A contact pin 23 is disposed so as to come into contact with the outer surface of the expanded portion 23 and supported by a supporting member 24 inside the handle 13.

FIG. 3B illustrates an external appearance of the contact pin 23, and FIG. 3C shows an internal structure of the contact pin 23.

The contact pin 23 has the structure that a ball 25 made of a metal having a high wear resistance is buried in a distal end of a contact pin body 26. The contact pin body 26 is fixed on the supporting member 24 by screwing with threads formed on an outer periphery of the contact pin body 26. Inside the contact pin body 26, a spring member 27 is disposed behind the ball 25. In this structure, the spring member 27 is compressed by a screw member 28.

As a cutting operation progresses, when the handle 13 is turned to push the blade 1 toward a material to be cut, the shaft 11 rotates and moves in a direction approaching the blade 1. However, since the concave portions 22 are formed on the expanded portion 21 of the shaft 11 at regular intervals, the shaft 11 temporarily stops when the contact pin 23 fits one of the concave portions 22. From this position, when the handle 13 is further turned, the ball 25 moves along the expanded portion 21 with the spring member 27 being compressed. Then, when the ball 25 reaches a position where the contact pin 23 fits the next concave portion 22, the ball 25 is protruded by an elastic force of the spring member 27 and stops at the position corresponding to the concave portion 22.

Thus, while the handle 13 is turned, the position of the blade 1 is fixed in a step-by-step manner. Therefore, the position of the blade 1 is held without slipping when cutting a material by turning the cutter 10 with the handle 13. Accordingly, poor accuracy of a cut surface due to slipping of a blade can be prevented.

The ball 25 comes into contact with each of the concave portions 22 formed on the expanded portion 21 with a point contact. This causes hardly any wear on the ball 25 and enhances the durability. In addition, since the spring member 27 is disposed behind the ball 25 and compressed by the screw member 28, a length of the spring member 27 can be adjusted by varying a position of the screw member 28 so as to change an elastic force of the spring member 27. Consequently, the handle 13 can be made either easy to turn or hard to turn by simply adjusting the position of the screw member 28.

The present invention can be used as a cutter capable of cutting a pipe-shaped material so as to produce a cut surface which is almost perfectly perpendicular to a longitudinal direction of the material. In particular, it is useful for cutting a pipe made of a relatively soft material such as a copper pipe. The cutter can be employed when cutting a pipe used for plumbing an air-conditioner, for example.

What is claimed is:

1. A cutter with a blade having a blade edge provided on an outer periphery of a disc-like base plate, the blade comprising a level surface which is perpendicular to an axial direction of the base plate and a sloped surface which is provided on an opposite side of the level surface and slanted so that a thickness of the blade increases toward a central portion of the blade.

2. The cutter as claimed in claim 1, wherein an angle of the sloped surface against the level surface is 7 degrees or more.

3. The cutter as claimed in claim 1, comprising a handle for adjusting a cutting depth of the blade and means for fixing the blade in a certain position in a step-by-step manner when operating the handle.

4. The cutter as claimed in claim 2, comprising a handle for adjusting a cutting depth of the blade and means for fixing the blade in a certain position in a step-by-step manner when operating the handle.

5. The cutter as claimed in claim 3, wherein the means for fixing the blade in a certain position in a step-by-step manner has a mechanism comprising a plurality of concave portions formed at regular intervals therebetween on an expanded portion of a shaft to which the blade is mounted, and a contact pin which comes into contact with the concave portions, wherein the shaft is fixed when the contact pin fits one of the concave portions, the contact pin having a ball disposed at a distal end of the contact pin and a spring member which protrudes and retracts the ball with an elastic force of the spring member.

6. The cutter as claimed in claim 4, wherein the means for fixing the blade in a certain position in a step-by-step manner has a mechanism comprising a plurality of concave portions formed at regular intervals therebetween on an expanded portion of a shaft to which the blade is mounted, and a contact pin which comes into contact with the concave portions, wherein the shaft is fixed when the contact pin fits one of the concave portions, the contact pin having a ball disposed at a distal end of the contact pin and a spring member which protrudes and retracts the ball with an elastic force of the spring member.
